(19) United States
(12) Patent Application Publication
(10) Pub. No.: US 2006/0188650 A1
(43) Pub. Date: Aug. 24, 2006

(54) Rapid prototyping process

(76) Inventor: Hartmut Sauer, Wilnsdorf (DE)

Correspondence Address: FISH & RICHARDSON PC, P.O. BOX 1022, MINNEAPOLIS, MN, 55440-1022, US

(21) Appl. No.: 10/553,356

(22) PCT Filed: Apr. 15, 2004
(86) PCT No.: PCT/IB04/50463

§ 371 Date: Oct. 14, 2005

(30) Foreign Application Priority Data
Apr. 16, 2003 (DE) 103 17 797.3
Jan. 9, 2004 (DE) 102004001613.5

(51) Int. Cl. B28B 7/38

(52) U.S. Cl. 427/133; 205/70; 264/219; 427/455; 164/45

(57) ABSTRACT

Process for the manufacture of spraying, conversion, punching and/or casting tools as well as prototypes starting out from models characterised by the steps of: v. Roughening of the surface of the model without chemical pretreatment of the surface of the model; vi. Applying an intermediate layer of copper or nickel to the surface of the model, the metallic intermediate layer not being applied by thermal spraying, CVD, PVD or laser treatment; vii. Applying a metallic or ceramic coating onto the intermediate layer by thermal spraying; and viii. Removing the model from the intermediate layer.

The present invention relates to a process for the manufacture of spraying, conversion, punching and casting tools.

The conventional way of producing lost-wax casting models, spraying, conversion and punching tools as well as prototypes consists of manufacturing the prototype and/or the tools and models according to drawings on cutting and/or eroding machines.

More recent methods for the manufacture of models/prototypes consist of the rapid prototyping methods including, among other things, stereolithography, the methods of laminated object manufacturing, fixed deposit modelling and laser sintering.

In general, these processes have the common feature that a 3D CAD model is first produced. The 3D CAD constructions are converted in the CAD system to volume data. The 3D volume model for rapid prototyping is subsequently divided in the PC into cross-sections. These cross-sections have a layer thickness of approximately 0.1 to 0.2 mm. After transferring the data onto a rapid prototyping machine, the original form is made from polymer plastic bodies, paper, pulverised metal or in a similar manner, layer by layer.

The prototypes thus produced are frequently suitable for use only for assessing the functioning properties and design.

It is usually necessary for product development and optimisation to investigate material properties and behaviour as closely to the original as possible. For this purpose, those parts of the materials are required which are later used in series manufacture. To be able to produce the tools, for production and small series, casting trays, plastic spraying tools, aluminium spraying tools and conversion and punching tools are manufactured by mechanical working.

For the processes for the manufacture of tools, the rapid prototyping processes can be used partially.

An earlier procedure for making casting dishes for lost wax casting consists of repeatedly applying mud and sand to a wax model until a thick layer is formed around the model. Subsequently, the wax is removed by melting and the mould is fired. Only then can the desired part be cast.

For sand casting, negative wooden models are made which are then mounted onto panels and pressed into the upper and lower boxes by means of so-called moulding machines. After joining the upper and lower box, the cavities thus formed are filled with cast aluminium or cast steel.

In another process, the prototype/model is cast in a mould using a clay or ceramic mass. The negative proofs thus formed are dried in ovens. Liquid metal is subsequently introduced into the dried mould.

The prototypes thus produced need to be processed further by mechanical operating methods such as grinding and polishing.

These earlier methods, such as the manufacture of wooden models, are time-consuming and can take several weeks in the case of complicated parts.

Apart from these conventional processes, more modern and more rapid operating processes (rapid tooling) are used. The technology of rapid prototyping is, in this case, used for the manufacture of tools.

One of these more recent methods is laser sintering. In this case, a laser melts a ceramic powder, such as zirconium silicate, in layers around the model to form a casting mould.

Methods such as laser sintering are rapid but require a relatively expensive machinery outfit.

A further method for the manufacture of moulding, spraying and pressing tools consists of scanning the prototype on a measuring machine and passing the data to a CNC machine. Alternatively, CAD data can be used.

Due to the tool or scanning head geometry, it is frequently impossible to manufacture an accurate tool. A tool thus manufactured must be made suitable for use by time-consuming additional machining.

When manufacturing large tools, moreover, it is necessary in the case of more modern methods such as e.g. stereolithography or laser sintering, to divide the models or prototypes into segments which are joined later to form the tool since the machines do not exceed a certain size (approximately 400 mm×600 mm).

From U.S. Pat. No. 6,305,459 it is known to coat mould cores of plastic, whose interior is cooled, externally by thermal spraying with a metallic layer. A disadvantage of this process is that only simple rotation-symmetrical articles can be coated with a corresponding layer. Flat structures not exhibiting a rotation axis cannot be metallised by this process since, as a result of the geometry, so-called hot spots, i.e. local superheated areas, are formed and the plastic substrate melts as a result of the thermal energy used.

Moreover, U.S. Pat. No. 6,257,309 B1 describes a process for the manufacture of an injection moulding mould which can be manufactured by thermal spraying. A disadvantage of this process is that the positive proof of the model has to be manufactured from a material whose melting or softening temperature is above the temperature of the material applied by thermal spraying. This means that a mould of tool steel can be manufactured according to the process presented in U.S. Pat. No. 6,257,309 B1 only if the models used have a melting or softening temperature of more than 1600° C. Consequently, only models of ceramics can be used in this case. The manufacture of such ceramic models, however, is highly time-consuming. For this reason, this process is hardly suitable at all for the manufacture of models with low tolerances.

From GB 2 367 073, a process is known, in the case of which a mould is manufactured by thermal spraying using a model which is manufactured by milling of a soft metal block. After milling, i.e. before thermal spraying, a layer of copper is applied to the soft metal.

A disadvantage in the case of this process is the highly time-consuming manufacture of the model. As a result of the need for the cutting manufacturing process, it is not possible to manufacture models with fine surface contours or corresponding moulded parts. In addition, the manufacture of larger models requires a considerable time expenditure which may be one of the reasons why, so far, no economic application has been found for this process.

Moreover, a process for the manufacture of casting mould tools for the motor vehicle industry is known from EP 0 781 625 A1, in which initially a negative model is produced by stereolithography. A ceramic proof is then made from this negative model. In order to maintain the tolerances required for the motor vehicle industry, this proofing method is highly time consuming. The moulds must first be frozen and subsequently fired ceramically. The sintered ceramic mould is subsequently coated with tool steel by thermal spraying. A disadvantage of this process—apart from the highly time consuming manufacturing process—is the fact that relatively large moulds cannot be manufactured using this process since, as a result of the high thermal energy, such relatively large moulds would exhibit delaminations or cracks in the ceramic model. For this reason, the manufacture of fairly large conversion tools such as those used in the motor vehicle industry, for example, to manufacture motor vehicle bonnets, is possible only by manufacturing several smaller moulds which are finally joined to form one large mould. However, this leads to problems regarding the dimensional correctness of the conversion tools.

Consequently, the invention is based on the object of providing as process by means of which casting, spraying, conversion and punching tools can be manufactured rapidly and accurately. The manufactured tools should be suitable both for small series and for production.

According to the invention, this object is achieved by a process for the manufacture of spraying, conversion, punching and/or casting tools as well as prototypes starting out from models characterised by the steps of:
i. Roughening of the surface of the model without chemical pretreatment of the surface of the model;
ii. Applying an intermediate layer of copper or nickel to the surface of the model, the metallic intermediate layer not being applied by thermal spraying, CVD, PVD or laser treatment;
iii. Applying a metallic or ceramic coating onto the intermediate layer by thermal spraying; and
iv. Removing the model from the intermediate layer.

In contrast to the known processes of the state of the art, no negative proof of the model, e.g. consisting of ceramics or metal, is used in the process according to the present invention. In this way, it is possible to operate with greater precision and to avoid making such a negative proof which is both time-consuming and technically demanding.

The spraying, conversion, freestanding and casting tools thus manufactured can be backfilled in a further step following step iii or step iv. In this case, a corresponding mass is applied onto the coating in order to ensure the rigidity of the mould, to guarantee acceptance by the press and, on the other hand, to evenly discharge the energy arising during pressing or conversion. Back-filling can take place either using the same material as applied by thermal spraying. However, it is also possible to use other materials, if necessary with metal particles or fibre-reinforced epoxy resins.

In a further embodiment according to the invention, it is also possible to remove the intermediate layer after step iii or iv. Obviously, the model must be removed from the manufactured mould beforehand. This process variant should be selected in those cases where the intermediate layer of copper or nickel applied would have a negative behaviour when the corresponding tools are used.

With regard to possible back-filling of the coating of the casting tool manufactured by the process according to the invention, the thickness of the coating does not play a decisive part. However, with respect to a possible dimensional accuracy, it is advantageous if the coating has an average thickness of at least 4 mm.

As mentioned above, it is possible for the first time to manufacture dimensionally accurate casting tools of tool steel in a simple manner by using the process according to the invention. According to a preferred embodiment, the coating exhibits a hardness of at least 35 HRC, in particular of 50 HRC.

As a result of the high hardness, a high resistance to wear and tear is achieved. The model can be made of all current materials.

In particular, it can be made of a plastic, preferably of CRP, polyamide, polymer resin, polyethylene, polypropylene, PMMA, GRP, polyvinyl chloride, polystyrene, epoxy resin, polyether ether ketone, polyether imide, polycarbonate, polyphenyl sulphone, polyurea, NBR, SBR, polytetrafluoroethylene and phenol resin.

In a preferred manner, this plastic model can be produced by stereolithography, laminated object manufacturing (LOM) or by laser sintering. In this way, dimensionally correct models can be produced particularly simply in a very short time. However, it is also possible to make the model from wood or paper. Laminated object manufacturing (LOM) is a preferred manufacturing process also in this case.

Particularly preferably, the process according to the invention is a process in which roughening of the surface of the model is carried out using a blasting agent, preferably silicon carbide with the granulation P80.

The pretreatment of the surface can be carried out by means of a modified pressure blasting unit. The pressure blasting unit is operated at a pressure of 4 bar. A boron carbide nozzle with a diameter of 8 mm, for example, can be used as blasting nozzle. The blasting time is on average 4.6 s. However, it can also be between 1 s and 15 s. Preferably, SiC with the granulation P80 with an average grain diameter of 200 to 300 μm is used as blasting agent. Other blasting agents which can be used are glass beads, broken glass, ceramics, noble corundum, mixed corundum, standard corundum, cast steel, cat-wire abrasive, chill casting, alusate, shell granules or dry strip.

In order to adjust the blasting system specifically to the requirements of the plastic modification to be treated regarding the reproducible surface topographies, 2 pressure circuits can be installed, one each for conveying the blasting agent and the actual acceleration process. This modification provides a highly constant volume stream and a large pressure area.

A compressed air stream conveys the blasting agent to the nozzle at a pressure which is as low as possible. The flow conditions guarantee a low wear and tear of the unit and the blasting agent as a result of a high volume flow of the blasting agent and a low proportion of compressed air. Only at the end of the conveying hose in front of the mixing nozzle is the cross-section reduced in order to adjust the desired volume stream. In the case of the plastic pretreatments, a constant volume stream of 1 l/min is preferably selected. However, volume streams of between 0.1 l/min and 3 l/min can also be selected. In the second part of the system, compressed air (volume stream 1) passes to the nozzle, it being possible to adjust the air steplessly within a pressure region of 0.2-7 bar. The blasting agent which is conveyed into the mixing nozzle at a very low flow rate is then accelerated by the high flow rate of the compressed air stream.

In a further embodiment which is also particularly preferred, the intermediate later is coated with copper or nickel using a chemical process without external current.

As the designation of the process already indicates, no electric energy is supplied from outside during the coating process in the case of the metal deposition without electric current but instead the metal layer is deposited exclusively by a chemical reaction. The metallisation of non-conductive plastics in a metal salt solution operating by chemical reduction requires a catalyst at the surface in order to interfere with the metastable equilibrium of the metal reduction bath there and to deposit metal on the surface of the catalyst. This catalyst consists of noble metal seeds such as palladium, silver, gold and occasionally copper which are added onto the plastic surface from an activator bath. However, an activation with palladium seeds is preferred for process technology reasons.

Essentially, the activation of the substrate surface takes place in two steps. In a first step, the structural part is immersed into a colloidal solution (activator bath). In this respect, the palladium seeds necessary for the metallisation and already present in the activator solution are adsorbed to the plastic surface. After seeding, the tin(II) and/or tin(IV) oxide hydrate which is additionally formed on immersion into the colloidal solution is dissolved by rinsing in an alkaline aqueous solution (conditioning) and the palladium seed is exposed as a result. After rinsing, nickel coating or copper coating can take place using chemical reduction baths.

This is effected in a bath maintained in metastable equilibrium by means of a stabiliser, which bath contains both the metal salt and the reducing agent. The baths for the nickel and/or copper deposition have the characteristic of reducing the metal ions dissolved therein at the seeds and to deposit elementary nickel or copper. In the coating bath, the two reactants must approach the noble metal seeds on the plastic surface. As a result of the redox reaction taking place in this way, the conductive layer is formed, the noble metal seeds absorbing the electrons of the reducing agents in this case and releasing them again when a metal ion approaches. In this reaction, hydrogen is liberated. After the palladium seeds have been coated with nickel and/or copper, the layer applied takes on the catalytic effect. This means that the layer grows together starting out from the palladium seeds until it is completely closed.

As an example, the deposition of nickel will be discussed in further detail here. During coating with nickel, the seeded and conditioned plastic surface is immersed into a nickel metal salt bath which permits a chemical reaction to take place within a temperature range of between 82° C. and 94° C. In general, the electrolyte is a weak acid with a pH of between 4.4 and 4.9.

However, in a further embodiment which is also preferred, it is also possible to apply one or more metallic layers additionally onto the intermediate layer thus applied without electric current, in particular by an electrolytic process.

The thin nickel coatings applied can be strengthened with an electrolytically deposited metal layer. Coating of structural parts with layer thicknesses of >25 μm is not economical because of the low rate of deposition of chemical deposition processes. Moreover, only a few coating materials can be deposited using the chemical deposition processes such that it is advantageous to make use of electrolytic processes for further industrially important layer materials. A further essential aspect consists of the different properties of layers chemically and electrolytically deposited with layer thicknesses of >25 μm, e.g. levelling, hardness and gloss. The bases of electrolytic deposition have been described e.g. in B. Gaida, “Einführung in die Galvanotechnik” (Introduction into electroplating) “E.G. Leuze-Verlag, Saulgau, 1988 or in H. Simon, M. Thoma, “Angewandte Oberflächentechnik für metallische Werkstoffe” (Applied surface technology for metallic materials) “C. Hanser-Verlag, Munich (1985).

Plastic parts which exhibit an electrically conductive layer as a result of a coating processes applied without electric current differ with respect to electrolytic metallisation only slightly from those of the metals. Nevertheless, a few aspects should not be disregarded in the case of the electrolytic metallisation of metallised polymers. As a result of the usually low conductive layer thickness, the current density must be reduced at the beginning of electrolytic deposition. If this aspect is ignored, a detachment and combustion of the conductive layer may occur. Moreover, care should be taken to ensure that undesirable layers of tarnish are removed by pickling baths particularly adapted for this purpose. Moreover, inherent stresses may lead to the destruction of the layer. In the case of deposits of nickel layers from an ammonia-containing bath, tensile stresses of the order of 400 to 500 MPa, for example, may occur. By means of additives such as saccharin and butine diol, a change to the structure of the nickel coatings in the form of a modified grain size and the formation of microdeformations may promote the decrease in internal stresses which may have a positive effect on a possible premature failure of the coating.

Examples of metal layers applied without external current are described in detail in the handbook of AHC Oberflächentechnik (“Die AHC-Oberfläche” Handbuch für Konstruktion und Fertigung, (“The AHC surface” Handbook for construction and manufacture”) 4^{th} edition 1999).

In a further particularly preferred embodiment of the present invention, a layer of aluminium, titanium or their alloys is applied onto the metallic layer, deposited without electric current, of the article according to the invention, the surface of the top-layer being anodically oxidised or ceramic coated.

Such layers of aluminium, titanium or their alloys oxidised or ceramic-coated by the anodic route are known on metallic articles and are marketed for example, under the trade name Hart-Coat® or Kepla-Coat®, for example, by AHC Oberflachentechnik GmbH & Co. OHG. These layers are characterised by a particularly high hardness and a high operating resistance and resistance to mechanical stresses.

Between the metallic layer of the article according to the invention deposited without electric current and the layer of aluminium, titanium or their alloys, one or several further metallic layers can be arranged.

The further metallic layers ranged between the layer deposited without electric current and the aluminium layer are selected according to the purpose of use. The selection of such intermediate layers is well known to the expert and described e.g. in the book “Die AHC-Oberfläche—Handbuch für Konstruktion und Fertigung (The AHC surface—Handbook for construction and manufacture”) 4^{th} enlarged edition 1999.

It is also possible for the surface of such an article to be a ceramic oxide layer of aluminium, titanium or their alloys which is coloured black by foreign ion embedment.

The ceramic oxide layer of aluminium, titanium or their alloys which is coloured black by foreign ions is of particular interest for high value optical elements, in particular in the aircraft and aerospace industry.

The manufacture of ceramic oxide layers coloured black by foreign ion embedments has, for example, been described in U.S. Pat. No. 5,035,781 or U.S. Pat. No. 5,075,178. The manufacture of oxide ceramic layers on aluminium or titanium is described e.g. in EP 0 545 230 B1. The manufacture of anodically produced oxide layers on aluminium is described e.g. in EP 0 112 439 B1.

In a further embodiment of the process according to the invention, the model equipped with the intermediate layer can be positioned and fixed in a frame.

This variant should be selected if the outside dimensions of the part to be manufactured have been preselected. As a result, mechanical additional working is reduced.

Within this framework, the coating can be filled or back-filled. Thermal spraying or filling by casting with an epoxy resin containing metal particles, if necessary, or with aluminium-containing foams is suitable in particular.

According to an embodiment of the present invention which is particularly preferred, the coating applied by thermal spraying is an alloyed tool steel.

In this way, it is possible to manufacture highly resistant tools extremely resistant to wear and tear in a simple manner within the shortest possible time.

A possibility for manufacturing such coatings consists of thermal spraying by means of a spraying powder which preferably consists of 30-50% by weight molybdenum powder and 70-50% by weight steel powder. Particularly preferably, such a powder is one consisting of 50% by weight molybdenum powder and 50% by weight steel powder.

The tools thus manufactured are suitable for normal use in production, i.e. their resistance to stress is in no way inferior to tools made in a conventional manner from the same material. In this way, it has been possible for the first time to manufacture a tool ready for production within a very short time which tool, moreover, exhibits major advantages regarding its dimensional accuracy.

1. Process for the manufacture of spraying, conversion, punching and/or casting tools as well as prototypes starting out from models characterised by the steps of:
i. Roughening of the surface of the model without chemical pretreatment of the surface of the model;
ii. Applying an intermediate layer of copper or nickel to the surface of the model, the metallic intermediate layer not being applied by thermal spraying, CVD, PVD or laser treatment;
iii. Applying a metallic or ceramic coating onto the intermediate layer by thermal spraying; and
iv. Removing the model from the intermediate layer.

2. Process according to claim 1 characterised in the coating is backfilled after step iii or iv.

3. Process according to claim 1 characterised in that the intermediate layer is removed after step iii or iv.

4. Process according to claim 1 characterised in that the coating exhibits an average thickness of at least 4 mm.

5. Process according to claim 1 characterised in that the coating exhibits a hardness of at least 35 HRC, in particular of more than 50 HRC.

6. Process according to claim 1 characterised in that the model consists of plastic, preferably of CRP, polyamide, polymer resin, polyethylene, polypropylene, PMMA, GRP, polyvinyl chloride, polystyrene, epoxy resin, polyether ether ketone, polyether imide, polycarbonate, polyphenyl sulphone, polyphenylene sulphide, polyarylamide, polyurea, NBR, SBR, polytetrafluoroethylene or phenol resin.

7. Process according to claim 1 characterised in that the model is made of plastic, preferably by stereolithography, laminated object manufacturing (LOM) or laser sintering.

8. Process according to claim 1 characterised in that the model is made of wood or paper.

9. Process according to claim 1 characterised in that the roughening of the surface of the model is carried out with a blasting agent, preferably with silicon carbide with the granulation P80.

10. Process according to claim 1 characterised in that the intermediate layer is coated with copper or nickel using a chemical process without electric current.

11. Process according to claim 10 characterised in that a further metallic layer is applied onto the intermediate layer applied without electric current, in particular by an electrolytic process.

12. Process according to claim 1 characterised in that, onto the metallic layer deposited without electric current, a layer of aluminium, titanium or their alloys is applied whose surface is anodically oxidised or ceramics treated.

13. Process according to claim 12 characterised in that one or several metallic layers are also arranged between the metallic layer deposited without electric current and the layer of aluminium, titanium or their alloys.

14. Process according to claim 12 characterised in that the surface of the article is a ceramic oxide layer of aluminium, titanium or their alloys, which layer is coloured black by foreign ion embedments.

15. Process according to claim 1 characterised in that the model provided with the intermediate layer is positioned and fixed in a frame.

16. Process according to claim 15 characterised in that the coating is filled or backfilled within the frame, in particular by thermal spraying or casting with an epoxy resin containing metal particles, if necessary, or with aluminium-containing foams.

17. Process according to claim 1 characterised in that an alloyed tool steel is applied by thermal spraying.

18. Process according to claim 1 characterised in that a spraying powder which preferably consists of 30-50% by weight molybdenum powder 70-50% by weight steel powder, in particular of 50% by weight molybdenum powder and 50% by weight steel powder is applied by thermal spraying.
